(19) United States
(12) Patent Application Publication
(10) Pub. No.: US 2022/0273410 A1
(43) Pub. Date: Sep. 1, 2022

(54) Curing Light

(71) Applicant: CAO Group, Inc., West Jordan, UT (US)

(72) Inventor: Densen CAO, Sandy, UT (US)

(73) Assignee: CAO Group, Inc., West Jordan, UT (US)

(21) Appl. No.: 17/631,490

(22) PCT Filed: Jul. 29, 2020
(86) PCT No.: PCT/US2020/044108

§ 371 Date: Jan. 30, 2022

Related U.S. Application Data
(60) Provisional application No. 62/879,898, filed on Jul. 29, 2019.

(51) Int. Cl. A61C 13/15

(52) U.S. Cl. CPC A61C 19/004

(57) ABSTRACT

A curing light (300) may emit light in one or more directions through either a two-dimensional or a three-dimensional head (301). When using a head (301) with three facets (304), (305), (306) each facet has a light source (309a), (309b), (309c) and a detector (308), which may or may not be integrated into a unit. Light sources (309a), (309b), (309c) may be activated in different sequences to cure composite within a structure, such as a tooth, with controls of light emitting in each facet. Light sources (309a), (309b), (309c) may also be controlled by utilizing feedback from detector (309) or other sensors. Detectors (308) may detect position, power, heat, or any other useful characteristic.

### CROSS-REFERENCES TO RELATED APPLICATIONS

This Application claims the benefit of priority from prior filed U.S. patent application Ser. No. 62/879,898, filed Jul. 29, 2019, and incorporates the same by reference in its entirety herein.

### TECHNICAL FIELD

The present invention is for use in the medical and dental fields and more particularly discloses curing lights with individualized light control for use in those fields.

### BACKGROUND ART

Curing light using LED as light source has been well adapted in dental and other industries. Prior art by the Inventor has described the key fundamentals to build an effective curing light using light emitting diodes as light sources and arrangements for LED and heat management. The Inventor has also addressed light emission in multiple directions by described a curing light that emits light from three mutually orthogonal directions. However, there is still a need to accurately position the light source with respect to a targeted curing area to improve the curing of the materials. The prior art has described many different types of LEDs as a light source for curing light; yet, light intensity at the curing surface is a critical parameter. An LED light source that can provide feedback signal to control board to enable light intensity at curing surface is always consistent. The present invention not only allows for accurate reporting of the position of the curing light with respect to the targeted curing area, but also provides feedback as to power and temperature so that the emitted light may be adjusted for optimal curing. The invention also allows for individual light sources to be activated or deactivated to adjust the directions from which light strikes the curing area.

### DISCLOSURE OF THE INVENTION

In view of the foregoing disadvantages inherent in the known types of curing lights, an improved curing light may provide a curing light with enhanced data feedback and control. A curing light according the present invention should meet the following objectives: that it be intuitive to operate, that it integrate with existing training protocols, that it provide feedback to the practitioner such that the practitioner may adjust a procedure based upon the feedback, that it provide controls for said adjustment, and that it may auto-adjust for certain parameters. As such, a new and improved curing light may comprise individualized light source control and sensors to monitor parameters during a given procedure, along with automatic and manually operated subroutines in order to accomplish these objectives.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

In order to describe the manner in which the above-recited and other advantages and features of the invention can be obtained, a more particular description of the invention briefly described above will be rendered by reference to specific example embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a schematic view of one embodiment of a curing light having a three-dimensional head.

FIG. 2 is a schematic view of one embodiment of a curing light having a two-dimensional head.

FIG. 3 is a schematic view of one embodiment of a three-dimensional head for use with a curing light.

FIG. 4 is a schematic view of an alternate embodiment of a three-dimensional head for use with a curing light.

FIG. 5A is a schematic side view of a two-dimensional head.

FIG. 5B is a schematic bottom view of the two-dimensional head of FIG. 5A.

FIG. 6 is a schematic view depicting one suitable LED light source for use with the invention.

FIG. 7A is a schematic depicting an alternate LED light source suitable for use in the present invention.

FIG. 7B is a schematic sectional view of the LED light source of FIG. 7A.

FIG. 8 is a schematic view of a one embodiment of a connector for use with a curing light as described.

FIG. 9 is a schematic illustrating one possible control module for use with the present invention.

FIG. 10 is a basic schematic of a suitable electrical system for one embodiment of the invention.

### BEST MODES FOR CARRYING OUT THE INVENTION

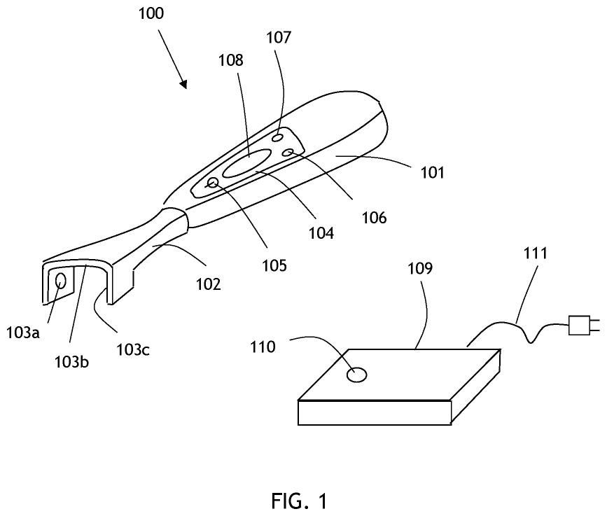

In one embodiment, as shown in FIG. 1, a curing light (100) is shown that is useful in dentistry and other industries. The curing light (100) has a main body (101) and a light head (102). The main body (101) contains control electronic circuits and a power source, such as a battery (as shown) or may draw external power from an AC/DC source. The light head (102) has an elongated body and a three-dimensional head. In the three-dimensional head, there are three LED light sources (103a) (shown), (103b), (103c) (obscured), positioned inside each facet, respectively, in each direction. In the main body (101), there is a control panel (104) including a power on/off switch (105), a timer adjustment button (106), a curing mode adjustment button (107), and a display (108) to display information for the light. A charging station (109) may be provided for the curing light (100) and it may utilize either a plug-in or wireless charging methodologies. The charging station may feature standard AC or DC power (111) and may have a radiometer (110) located in the charging station which serves as a fault check by read light intensity. The charging station can also be battery operated.

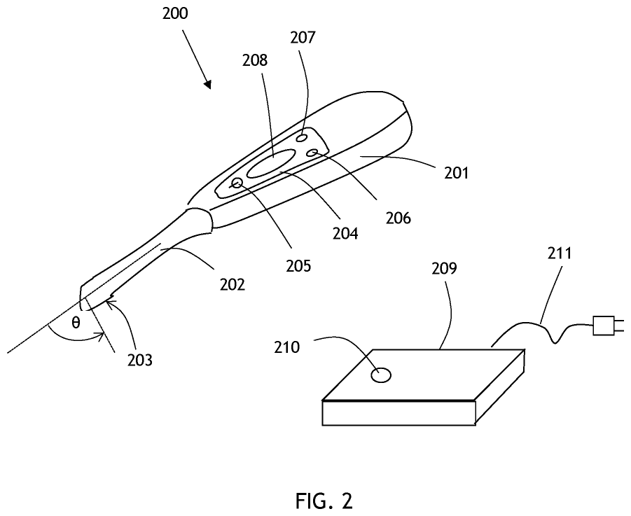

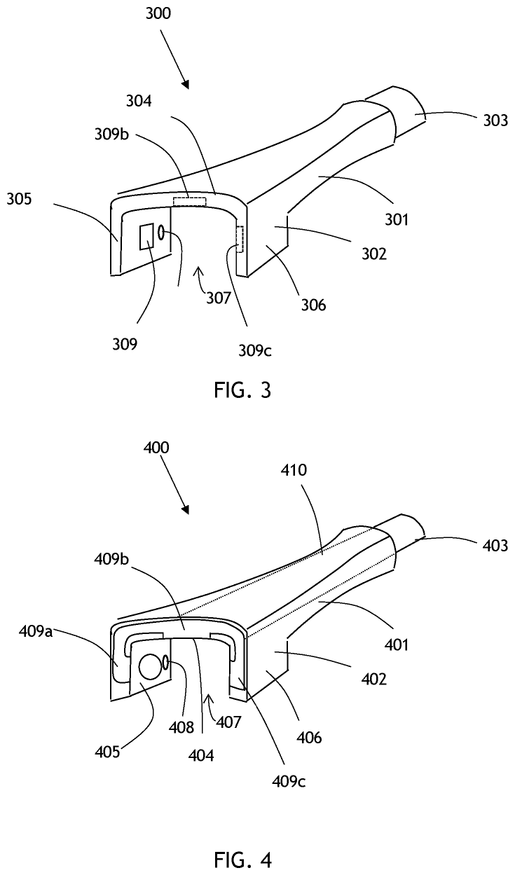

FIG. 2 depicts the overall profile of a curing body with a two-dimensional head (200) is a curing light that is useful in dentistry and other industries. The light (200) has a main body (201) and light head (202) which has an elongated head and LED light source (203) embedded in the end of the head. The light source may be angled with respect to an axis defined by the length of the head (dashed line) up to a 8 of 180 degrees. There is a control panel (204) in the main body including a power on/off switch (205) and a timer adjustment button (206) and curing mode adjustment button (207), and a display (208) to display information for the light. There is charging station (209) for the light. The charging for battery in the light can be plug in or wireless charging. The charging station may have a radiometer (210) and plug-in power (211). The charging station can also be battery operated.

A suitable three-dimensional head (300) for the embodiment shown in FIG. 1 has a body (301), a three-faceted head portion (302), and a connector (303). The three facets (304), (305), (306) form a three-dimensional inner space (307) in which a curing object will seat in. On the inner side of each facet is at least one detector (308) (two obscured by facets (304) and (306)) and at least one LED light source (309a), (309b), (309c). Connector (303) provides connection of electrical power to LED sources and connects connectors (308) to main body for control. The connector (303) may have multiple contacts based on the configuration of LED setup.

FIG. 4 depicts an alternate optical structure of for a three directional head (400). The head (400) has an elongated body (401) and a three-faceted head portion (402) and a connector (403) as with the previous embodiment. Likewise, the three facets, (404), (405), (406) form a three-dimensional inner space (407) to be positioned around the targeted object.

There is a light guide (410) in the body with a light inlet in connector (403). The light guide (410) splits into three branches at end of other side (409a), (409b), (409c) respectively. The split light guides to be shaped to deliver light to each of the three facets. This light guide design can also provide a three-dimensional light to a cured object with one light source input. The materials of light guide can be plastic, fibers, fiber bundles, and any materials that are suitable to conduct light. Detectors (408) provide feedback through the connector (403) as described before.

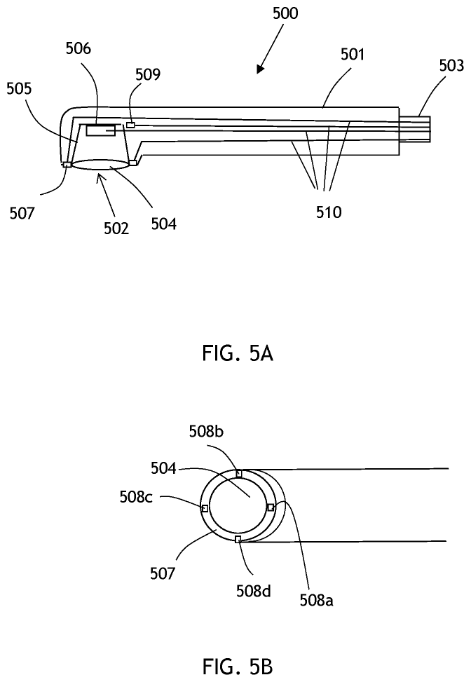

FIGS. 5A and 5B depict a structure for a two-dimensional light (500), such as shown in FIG. 2, with position sensors (508). In FIG. 5A, curing head (500) has an elongated body (501). At one side of body, there is a light exit (502) and an electrical connector (503) opposite. There is an optical lens (504) housed in the light exit (502) and a reflector (505) with an LED source 506 therein. FIG. 5B illustrates top view of the curing light head where (504) is optical lens for light exit and it features a ring (507) thereabout. Detectors (508a), (508b), (508c), and (508d), are housed on the ring (507) with preference given to the 0, 90, 180, and 270-degree positions. The detectors are used to detect the position of the head relative to curing object and other parameters. Each detector will detect the reflection light from the cured surface. If the head is off the position of cured surface, one of detectors will provide a different signal to control board and electronic control will provide warning. The detector may also be used to feedback to circuit control for adjusting light intensity to maintain emitting light intensity is the same if the light head is away from curing surface. There may also be a heat detector (509) by the LED are to monitor temperature of curing body. There are connecting wires (510) for LED, detectors, and heat sensor (509). All three of these heads, and any others developed, may interface interchangeably with an overarching system through the connections (303), (403), and (503).

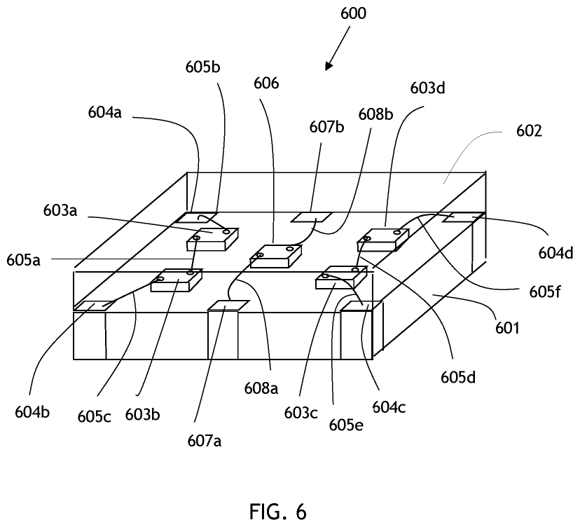

FIG. 6 depicts one LED embodiment (600) useful as light source in the practice of the invention as it includes a feedback sensor (606) in the source itself (600) and does not require a separate sensor as is illustrated in the previous embodiments. LED lead frame (601) can be manufactured from materials like ceramics, metal, metal PCB, alloy, composite, and any materials that are useful as lead frame for LEDs. In this embodiment, the lead frame (601) has a relatively flat surface and a cover (602) which is illustrated as a flat cover and serves as a lens. The cover (602) can be also any type of lens to shape the lights emitted from LED chips, which can be any type of emitting lights. An external lens can also be used to shape the beam of emitted lights or collecting lights. The cover (602) is made of transparent materials to emitted lights and reflected lights from object, such as plastic, silicon, glass, composites, and any other materials that are suitable as a cover. The cover (602) can be coated with phosphors for conversion of mono wavelengths to different cover, including a white color. LED chips (603a), (603b), (603c), (603d) are bonded to the lead frame (601) and are provided wire bonding pads (604a), (604b), (604c), (604d), respectively. The bonding pads can extend to side and bottom of lead frame (601) as connection for electricity. Bonding wires (605a), (605b), (605c), (605d), (605e), (605f) connect LED chips to the bonding pads. A light sensor or detector chip (606), which can be any type of sensor that absorb lights and convert light into an electrical signal, may also be mounted to the lead frame (601). While the preferred position of detector chip (606) is in the center of lead frame (601), it can be in any position depending the needs from application. The detector chip (606) is also provided wire bonding pads (607a), (607b) and connected thereto with bonding wires (608a), (608b). The bonding pads can extend to the side and bottom of lead frame (601) as connection for electricity. Cover (602) may also serve as a lens for the detector chip (606) or an external lens can be used be to generate a better signal. The lead frame (601) will provide electrical connections for LED chips and detector chips depending configuration of LED and detector chip connections. There should be at least one LED chip and at least one detector chip (606).

The working logistic is that detector (606) will detect a portion of light emitted by LED chips through direct detecting of emitted light or through detection of light reflected from an object that the LED is shining on and generate an electrical feedback signal to a control circuit and the control circuit will adjust LED emitting intensity as user desires through calibration and programming based on the feedback signal. This adjustment may be done automatically or may take the form of an indicator so that a practitioner may adjust the system manually.

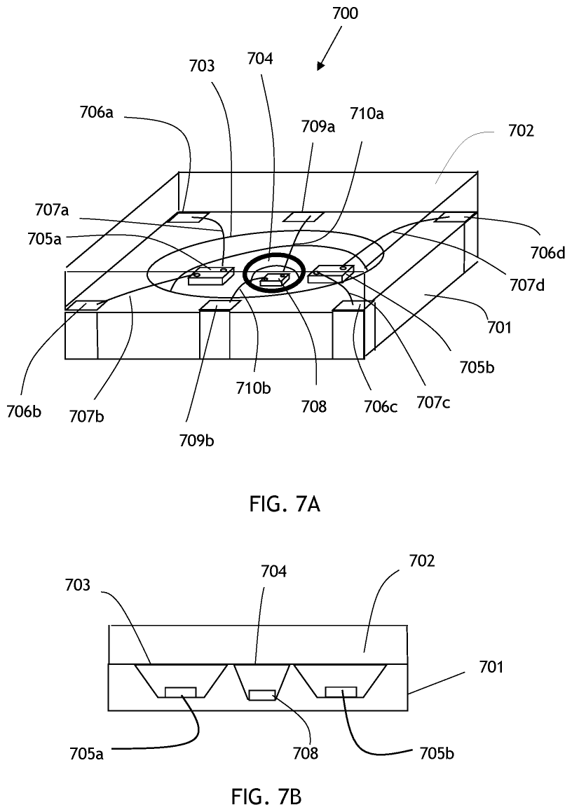

FIGS. 7A and 7B depict another LED embodiment (700) useful as a light source. As with the prior embodiment, lead frame (701) can be from materials like ceramics, metal, metal PCB, alloy, composite, and any materials that are useful as lead frame for LEDs and is provided a cover (702) to function as a lens. The cover (702) can be also any type of lens to shaping the lights emitted from LEDs, though it is illustrated as flat in the figure. An external lens can also be used to shape the beam of emitted lights or collecting lights. The cover (702) is made of transparent materials to emit lights and/or reflect lights from an object, such as plastic, silicon, glass, composites, and any other materials that are suitable as a cover. The cover (702) can also be coated with phosphors for conversion of mono wavelengths to different colors, including a white color. In this embodiment, lead frame has two wells, 703 and 704, respectively. The wells are for housing LED chips (705a), (705b) and detector chip (708) respectively. LED chips (705a), (705b) are bonded to the lead frame (701) in outer well (703). Wire bonding pads (706a), (706b), (706c), and (706d) are provided for LED chips, which are interconnected with bonding wires (707a), (707b), (707c), (707d), respectively. The bonding pads can extend to side and bottom of lead frame (701) for connection of electricity. The LED chips can be any types sufficient to emit light. A light sensor or detector chip (708) may be located in the inner well (704) and it is preferred that the inner well (704) be situated in the center of lead frame (701), but it can be in any position depending on the needs of application. Detector chip (708) can be of any type of sensor that absorbs lights and converts that light into an electrical signal. Detector chip (708) is provided at least one wire bonding pad (709a), (709b) which may extend to side and bottom of lead frame (701) for connection of electricity. Bonding wires (710a), (710b) connect sensor (708) to bonding pads (709a), (709b). The lead frame (701) will provide electrical connections for LED chips and detector chips depending configuration of their connections. The quantity of LED chips in the device is at least one and the quantity of detector chip in the device is at least one. Cover (702) or an external lens can be used to collecting light for detector (708) to generate better signal. This LED structure operates in a similar manner to and perform similar functions as the previous one shown in FIG. 6, however the well (704) will prevent the sensor (708) from directly detecting light from the LED chips and and will only detect light from reflection of an object (i.e. a tooth).

FIG. 8 depicts a connector which may be used for either for light head. The connector head (800) for a curing light head may have a circular end (801) with multiple connecting pins (802), (803), (804), (805), (806), (807), (808), (809), and (810) respectively. The connecting pins will provide the electricity to LED source(s) and collect feedback signals from light sensors and heat detection sensor. The quantity of connecting pins depends on the configuration of LED and sensors for curing head.

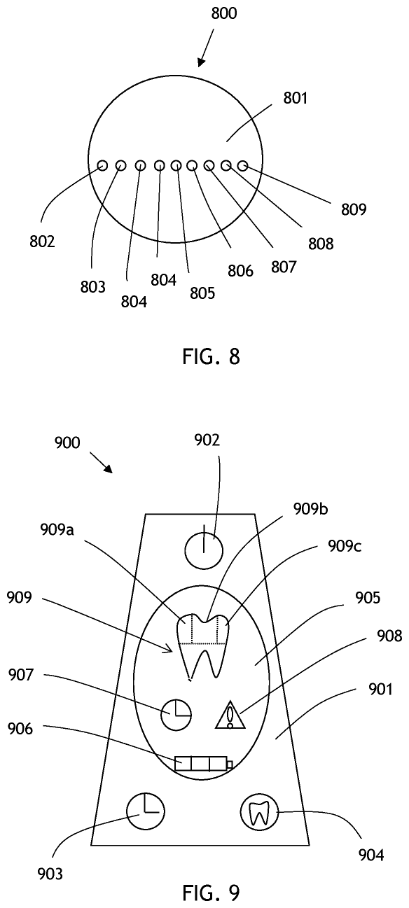

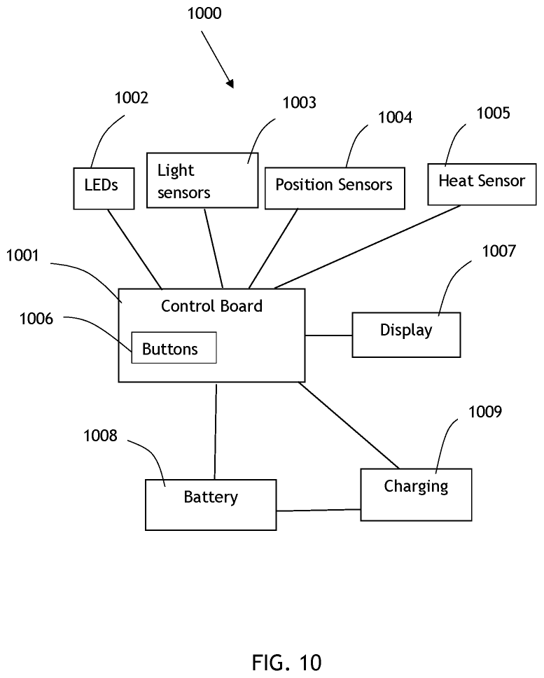

FIG. 9 depicts a potential control interface (900) of a curing light system with a control panel (901). Panel (901) features switches for power (902), time adjustment (903), and curing direction (904). A display (905) may also be provided, with a battery indicator (906), timer indicator (907), a warning indicator (908), and a curing mode indicator (909) which will show from which direction light will emit. Any signs that are required to make the curing light functional can be displayed in the display. Most important display is curing mode. The curing can be initialized from all three different facets as illustrated in FIG. 1. The curing mode can be combination of all three facets in different sequences. It should be noted that this functionality cannot be utilized with the fiber head embodiment of FIG. 4 at this time, however future developments may make this possible and, in any event, the detection of conditions and light position in the curing area will still provide a more efficient and effective curing process than is available in the prior art.

Examples of curing modes can be as follows:

| | Mode | Mode | Mode | Mode | Mode | Mode | Mode |
|---|---|---|---|---|---|---|---|
| Facet | 1 | 2 | 3 | 4 | 5 | 6 | 7 |
| Facet 1 | On | On | On | Off | Off | Off | On |
| (909a) | | | | | | | |
| Facet 2 | On | On | Off | On | On | Off | Off |
| (909b) | | | | | | | |
| Facet 3 | On | Off | Off | On | Off | On | On |
| (909c) | | | | | | | |

FIG. 10 depicts an electrical schematic of curing light architecture (including wireless charging). The control board (1001) contains all necessary electronic, microprocessor, memory provide controls for operating the light, such as LED light source (1002), sensor(s) for detecting light (1003), sensors for position (1004), and at least one sensor for heat (1005) are connected to the control board (1001). Control buttons (1006) provide input signal to control board and the display (1007) is connected to control board to display information for user. The control board (1001) also senses the battery (1008) and battery charger (1009) information to provide information for display (1007) that user can observe.

### INDUSTRIAL APPLICABILITY

The present invention is readily made in industry and has applicability in the dental field. Although the present invention has been described with reference to preferred embodiments, numerous modifications and variations can be made and still the result will come within the scope of the invention. No limitation with respect to the specific embodiments disclosed herein is intended or should be inferred.

1. A curing light comprising:
a handheld unit having a head upon which at least one curing light source is mounted; and
at least one sensor to detect a characteristic of a volume about the curing light head, the characteristic of the volume about the curing light head being detected by the sensor being selected from the set of characteristics consisting of: position of the head relative a target object and emitted light intensity;
wherein the sensor relays information to a control unit and the information relayed to the control unit is used to adjust said detected characteristic.

2. (canceled)

3. The curing light of claim 1, the sensor detecting light intensity within the volume and the information relayed to the control unit is used to adjust said light intensity.

4. The curing light of claim 1, the sensor being integrated within the curing light source.

5. The curing light of claim 1, the head having three facets facing different directions into a volume, each facet with its own at least one curing light source and at least one sensor, each facet's at least one light source being independently operable from other facets' at least one light sources.

6. The curing light of claim 5, further comprising a control panel with operable controls to selectively change which facet's at least one curing light sources is activated.

7. The curing light of claim 5, the sensor detecting position of the head relative a target object and the information relayed to the control unit is used to adjust head position relative to said target object.

8. The curing light of claim 5, the sensor detecting light intensity within the volume and the information relayed to the control unit is used to adjust said light intensity.

9. The curing light of claim 5, the sensor being integrated within the curing light source.

10. A curing light comprising:
a curing head with three facets, each facet further comprising at least one discrete light source to emit lights in three directions and at least one discrete light sensor; and,
a control interface to control an emitting sequence of the light sources on the three facets for desired emitting conditions.

11. The curing light of claim 1 further comprising a plurality of detachable curing heads, each curing head of the plurality being selected from the set of curing heads consisting of a two-dimensional curing head and a three-dimensional curing head having three distinct light emitting facets.

12. A method of curing a substance with a curing light, said substance being positioned as a curing target, the method comprising:
a step of providing a curing light with three light emitting facets and a control interface, said facets defining a volume in which the curing target resides and each facet further comprising at least one discrete light source and at least one discrete light sensor;
a subsequent step of using the control interface to selectively activate at least one light emitting facet, thereby emitting light on at least one selected side of the curing target within the volume;
a further step of detecting characteristics of light emitted from the at least one light emitting facet through at least one light sensor;
a still further step of adjusting characteristics of the light emitted based open information received through the at least one light sensor to achieve optimal curing efficiency.

13. The method of claim 12, further comprising a third step using the control interface to selectively activate at least one other light emitting facet, thereby emitting light on at least one other side of the curing target.

14. The method of claim 12, wherein only two light emitting facets are selectively activated in the second step, thereby emitting light on two different sides of the curing target.
